(19) United States
(12) Patent Application Publication
(10) Pub. No.: US 2026/0144392 A1
(43) Pub. Date: May 28, 2026

(54) PICTURE FRAME

(71) Applicant: Inter IKEA Systems B.V., Delft (NL)

(72) Inventor: Gediminas MARKEVICIUS, Älmhult (SE)

(21) Appl. No.: 19/121,873

(22) PCT Filed: Oct. 20, 2023
(86) PCT No.: PCT/SE2023/051040

§ 371 Date: Apr. 17, 2025

(30) Foreign Application Priority Data
Oct. 21, 2022 (SE) 2251231-3

(51) Int. Cl. A47G 1/10; A47G 1/06

(52) U.S. Cl. CPC A47G 1/101; A47G 1/0605

(57) ABSTRACT

A picture frame including a first elongated frame part, a second elongated frame part, a third elongated frame part and a fourth elongated frame part. Each elongated frame part includes at a first end a connection element configured to releasably engage a receiving member arranged at a second end of another elongated frame part. Each of the connection elements extends in a direction transversal to a longitudinal extension of the elongated frame parts, and the connection element includes a guiding protrusion configured to guide the connection element into the receiving member.

### FIELD OF THE INVENTION

The present invention relates to a picture frame, and a method for manufacturing said picture frame.

### BACKGROUND

Picture frames may be formed from different materials, such as wood, metal or plastics. Typically, picture frames are manufactured as four separate elongated parts, attached to each other in the corners to form a picture frame.

When producing picture frames of plastics, it is common to form elongated profiles using extrusion, which may be cut to a desired length. An issue with extrusion of plastics is that the technique can only form symmetrical profiles. In order to join the cut elongated parts, separate corner elements are therefore necessary to form an assembled picture frame. Alternatively, the plastic frame is formed in one piece. However, such a frame if its width and height is relatively large, is hard for the user to transport and/or carry from the store.

In view of this, it would be advantageous to provide an improved picture frame, which is easy and inexpensive to manufacture, and which is simple to assemble.

### SUMMARY

The present invention seeks to mitigate, alleviate, eliminate or circumvent one or more of the above identified deficiencies in the art and disadvantages singly or in any combination by providing in a first aspect a picture frame comprising a first elongated frame part, a second elongated frame part, a third elongated frame part and a fourth elongated frame part. Each elongated frame part comprises at a first end a connection element configured to releasably engage a receiving member arranged at a second end of another elongated frame part, and each of said connection elements extends in a direction transversal to a longitudinal extension of the elongated frame parts.

The connection element and the receiving member may together form snap-fit connection. This facilitates mounting of the picture frame.

The receiving member may be an aperture, and the connection element may comprise a male protrusion configured to be inserted into the aperture.

The male protrusion may have a ledge configured to engage an inner edge of the receiving member.

The connection element may comprise a notch configured to be pressed to release the connection element from the receiving member.

The connection element may comprise a guiding protrusion configured to guide the connection element into the receiving member.

The receiving member may extend into the frame part in the longitudinal direction.

The picture frame may further comprise angle connections detachably connected to two adjacent elongated frame parts, preferably the picture frame comprises four angle connections.

Said angle connections may be connected to the picture frame with snap-fit elements arranged in each end of the angle connections.

Said angle connections may comprise biasing means configured to abut and press a canvas, picture, passepartout or back surface arranged in the picture frame into place.

According to a second aspect, an elongated frame part is provided. The elongated frame part comprises at a first end a connection element, and a receiving member arranged at a second end. The connection element is configured to releasably engage the receiving member of another elongated frame part, and the connection element extends in a direction transversal to a longitudinal extension of the elongated frame part.

The elongated frame part may be formed in one piece.

The elongated frame part may be formed by injection moulding.

According to a third aspect, a method for manufacturing a picture frame is provided. The method comprises i) forming a first elongated frame part, a second elongated frame part, a third elongated frame part, and a fourth elongated frame part, wherein each elongated frame part comprises at a first end a connection element configured to releasably engage a receiving member arranged at a second end of another elongated frame part, and wherein each of said connection elements extends in a direction transversal to a longitudinal extension of the elongated frame parts. The method further comprises ii) releasably connecting the elongated frame parts to each other to form said picture frame.

Forming the frame parts may comprise injection moulding the frame parts.

Connecting the elongated frame parts may comprise connecting the connection element of each elongated frame part with the receiving member of another elongated frame part.

Further advantageous features of the invention are elaborated in embodiments disclosed herein. In addition, advantageous features of the invention are defined in the dependent claims.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which:

FIG. 1 shows a picture frame according to the invention;

FIGS. 2a and 2b show a frame part according to the present invention;

FIG. 3 shows an enlarged view of a corner of the picture frame in FIG. 1;

FIG. 4 shows an angle connection attached to a frame part;

FIGS. 5 and 6a show an angle connection according to the present invention;

FIG. 6b shows a cross section of the angle connection according to the present invention; and

FIG. 7 shows a method of assembling the picture frame.

### DETAILED EMBODIMENTS

Hereinafter, certain embodiments will be described more fully with reference to the accompanying drawings. The invention may, however, be embodied in many different forms and should not be construed as limited to the embodiments set forth herein. Rather, these embodiments are provided by way of example so that this disclosure will be thorough and complete, and will fully convey the scope of the invention, such as it is defined in the appended claims, to those skilled in the art.

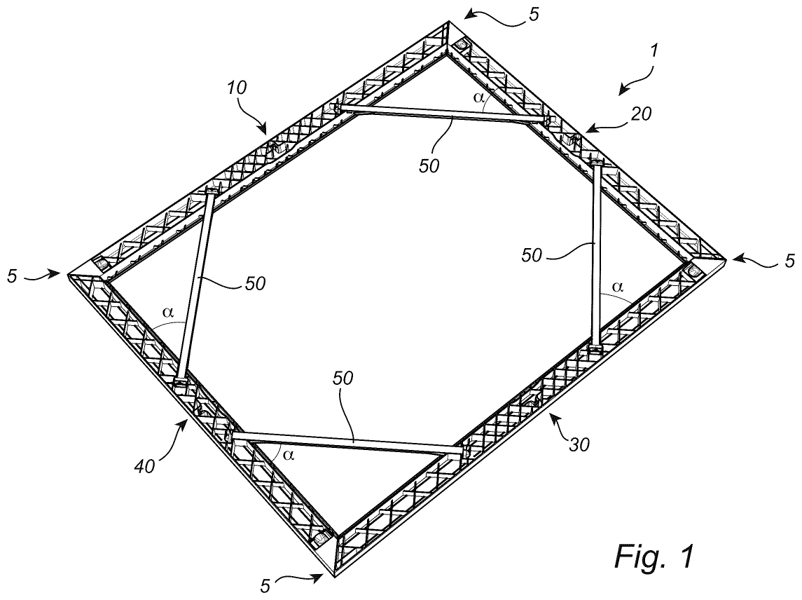

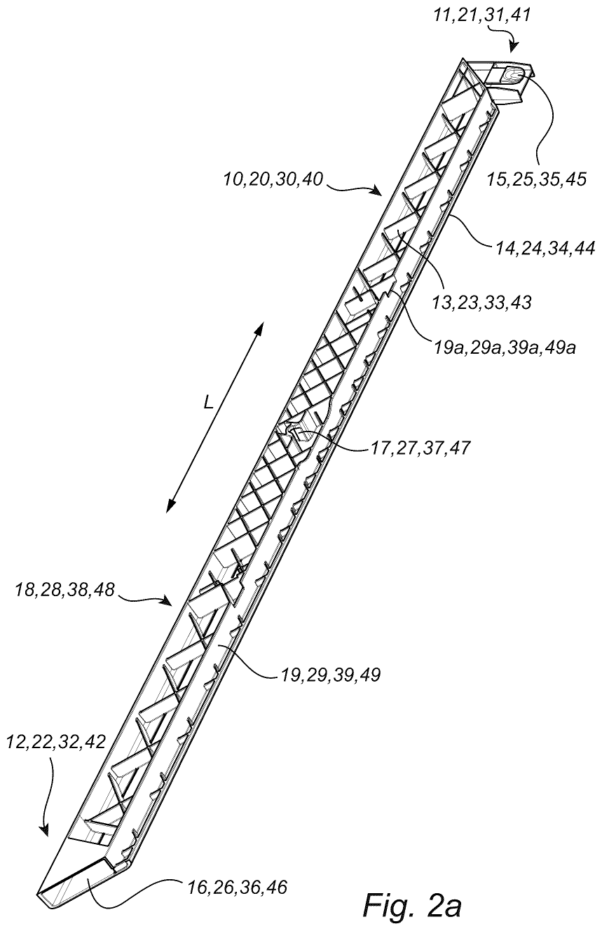

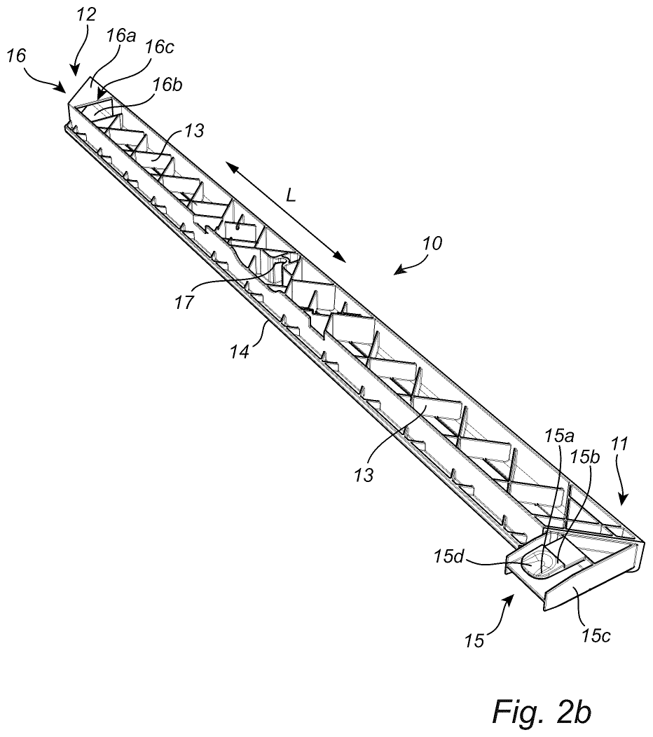

With reference to FIG. 1, a rear side of a picture frame 1 according to the present invention is shown. The picture frame 1, also referred to herein as the frame 1, comprises a first elongated frame part 10, a second elongated frame part 20, a third elongated frame part 30 and a fourth elongated frame part 40. The frame 1 has four corners 5, where two adjacent frame parts 10, 20, 30, 40 are joined. The frame 1 in FIG. 1 is rectangular. However, the frame 1 may have any other suitable shape. The frame 1 is made of plastic, preferably a thermosetting plastic. How the elongated frame parts 10, 20, 30, 40 are connected to each other will be explained more in detail with reference to FIGS. 2-4.

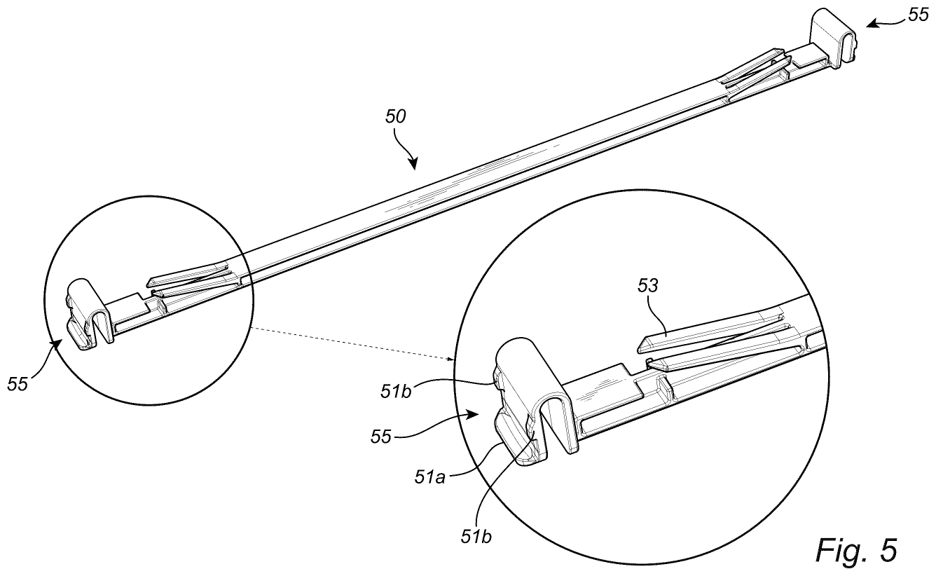

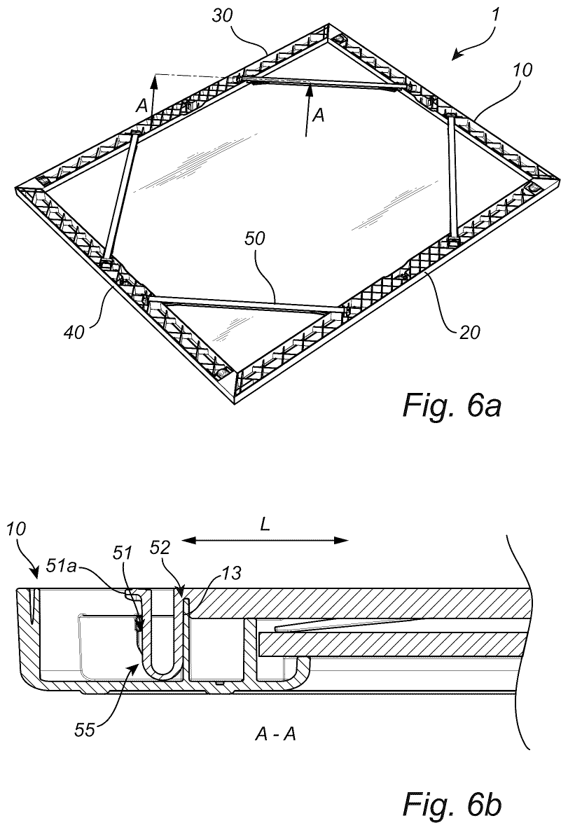

The frame 1 further comprises four angle connections 50, arranged between two adjacent elongated frame parts 10, 20, 30, 40. The angle connections 50 are releasably attached to the two frame parts 10, 20, 30, 40 at an angle α, preferably said angle a being between 30 and 60 degrees, most preferred about 45 degrees. While it is shown that each end of the angle connections 50 connects to the respective frame part 10, 20, 30, 40 by the same angle α, it should be noted that these could be different as long as the sum equals 90 degrees. The angle connections 50 will be described in detail with reference to FIGS. 5 and 6a-b.

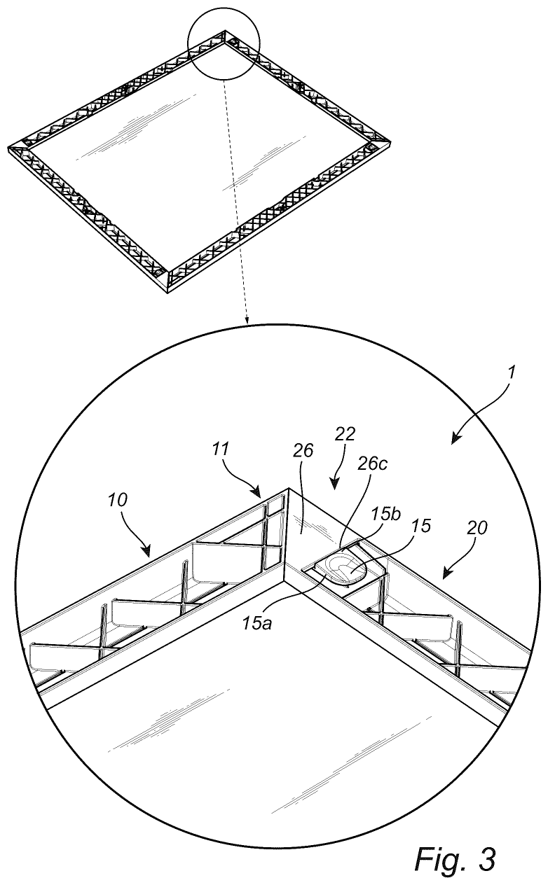

FIG. 2a shows an isometric view of one elongated frame part 10, 20, 30, 40 (also referred to as a frame part herein). The frame part 10, 20, 30, 40 extends along a longitudinal direction L. The frame part 10, 20, 30, 40 has a first end 11, 21, 31, 41 and a second end 12, 22, 32, 42. The first end 11, 21, 31, 41 is provided with a connection element 15, 25, 35, 45 and the second end 12, 22, 32, 42 is provided with a receiving member 16, 26, 36, 46. Each frame part 10, 20, 30, 40 further comprises a plurality of cross ribs 13, 23, 33, 43, a support flange 14, 24, 34, 44 extending along the longitudinal direction L and a slot opening 17, 27, 37, 47. The receiving member 16, 26, 36, 46 is configured to releasably engage the connection element 15, 25, 35, 45 arranged on the adjacent frame part 10, 20, 30, 40, as shown in FIGS. 1 and 3.

As shown in FIG. 2a, the receiving member 16, 26, 36, 46 is an aperture 16, 26, 36, 46 extending into the frame part 10, 20, 30, 40 along the longitudinal direction L. A width of the aperture 16, 26, 36, 46 substantially corresponds to a width of the connection element 15, 25, 35, 45.

Each frame part 10, 20, 30, 40 has an exterior side 18, 28, 38, 48 and an interior side 19, 29, 39, 49. The cross ribs 13, 23, 33, 43 are formed as a plurality of cross shaped portions, extending between the exterior side 18, 28, 38, 48 and the interior side 19, 29, 39, 49. The interior sides 19, 29, 39, 49 are each provided with recesses 19a, 29a, 39a, 49a configured to hold and receive the angle connections 50. The recesses 19a, 29a, 39a, 49a therefore have a shape corresponding to the outer shape and dimensions of the angle connections 50.

FIG. 2b shows an isometric view of the frame part 10 extending along the longitudinal direction L. The frame part 10 has the connection element 15 arranged at the first end 11, and the receiving member 16 arranged at the second end 12. The support flange 14 extends along the interior side 19 of the frame part 10 and the frame part 10 is provided with several cross ribs 13, and a slot opening 17.

The support flange 14 provides support for a picture, passepartout and/or a back surface of the frame 1. The cross ribs 13 provides a stable frame part 10 while ensuring that a low amount of material for manufacturing the frame part 10 is required. This results in a light and cheap frame part 10. In addition, the cross ribs 13 provide stiffness to the frame part 10 and also contribute to an optimized flexibility of the frame part 10.

The slot opening 17 makes it possible to hang the frame 1 onto a wall using e.g. a hook, nail or screw.

The connection element 15 shown in FIG. 2b comprises a protruding male portion 15a having a ledge 15b, and a guiding protrusion 15c having an H-shaped cross-section. The male portion 15a further comprises a notch 15d. The connection element 15 extends substantially perpendicular to the longitudinal direction L. Thus, the connection element 15 extends in a direction transversal in relation to the longitudinal direction L.

Preferably, the male portion 15a, and the guiding protrusion 15c are two separate parts. Preferably, the male portion 15a, and the guiding protrusion 15c each separately extend along transversally, most preferred substantially perpendicularly, to the longitudinal direction L. The guiding portion 15c is preferably stiff while the male portion 15a is flexible. The receiving member 16 is an aperture 16 extending along the longitudinal direction L. A depth of the aperture 16 corresponds at least to a length of the connection element 15. The receiving member 16 has an upper surface 16a and an end opening 16b. An inner edge 16c is configured to engage the ledge 15b of the connection element 15, as shown in FIG. 3. A length of the guiding portion 15c is preferably dimensioned such that an outer end pf the guiding portion 15c abuts the first cross rib 13 when the connection element 15 is attached to the receiving member 16. The first cross rib 13 extends straight, i.e. perpendicularly to the longitudinal extension L, between the external side 28 and the internal side 29 of the frame part 20. This is shown in the enlarged portion of FIG. 3.

The features shown on the first frame part 10 in FIG. 2b are present on each elongated frame part 20, 30, 40. Hence, the frame parts 20, 30, 40 also each comprises the cross ribs 23, 33, 43; the support flange 24, 34, 44; the slot opening 27, 37, 47; the male portion 25a, 35a, 45a; the ledge 25b, 35b, 45b; the guiding protrusion 25c, 35c, 45c; the notch 25d, 35d, 45d; the upper surface 26a, 36a, 46a; the opening 26b, 36b, 46b; and the inner edge 26c, 36c, 46c.

FIG. 3 shows an enlarged view of the corner 5 encircled in FIG. 1. In FIG. 3, the first frame part 10 is connected with the second frame part 20. The connection element 15 at the first end 11 of the first frame part 10 is inserted into the aperture 26 arranged in the second end 22 of the second frame part 20. As shown in FIG. 3, the ledge 15b abuts the inner edge 26c of the receiving member 26.

The male portion 15a, 25a, 35a, 45a of the connection element 15, 25, 35, 45 is resilient, such that the connection element 15, 25, 35, 45 and the receiving member 16, 26, 36, 46 together form a snap fit connection.

To assemble the plastic picture frame 1, the user mates and inserts the connection element 15, 25, 35, 45 on a frame part 10, 20, 30, 40 into the aperture 16, 26, 36, 46 of the adjacent frame part 10, 20, 30, 40 and pushes the connection element 15, 25, 35, 45 into engagement with the aperture 16, 26, 36, 46. The upper surface 16a will force the male protrusion 15a downwards from its resting state, and when the ledge 15b has passed the inner edge 16c of the aperture 16, the male protrusion 15a will spring/snap back upwards to its resting state. Hence, the connection between the connection element 15 and the aperture 16 is formed through a snap-fit engagement.

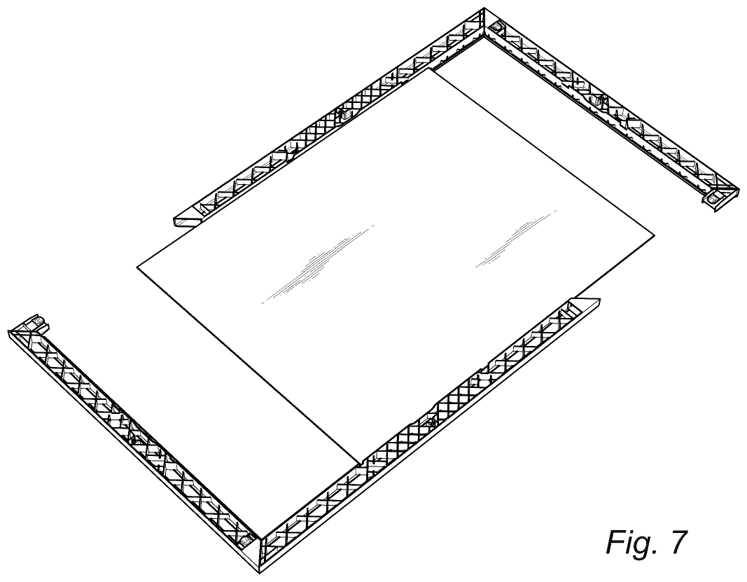

The user can either assemble two adjacent frame parts 10, 20 to form a first V-shaped frame portion and assemble the two adjacent frame parts 30, 40 to form a second V-shaped frame portion, and then assemble the first and second V-shaped frame portions together as indicated by the arrows in FIG. 7. Alternatively, the user may connect the first part 10, with the second part 20, then attach the second part 20 with the third part 30 and finally connect the fourth part to the first and third parts 10, 30 respectively. This is possible since the frame parts 10, 20, 30, 40 are made of plastics which is flexible enough to fit the final fourth frame part 40 into connection with the U-shaped formed frame portion comprising the first, second and third frame parts 10, 20, 30.

To disassemble the frame 1, the user presses the notch 15d, 25d, 35d, 45d downwards and simultaneously pulls the adjacent frame parts 10, 20, 30 40 away from each other such that the connection element 15, 25, 35, 45 is released from the engagement with the inner edge 16c, 26c, 36c, 46c of the receiving member 16, 26, 36, 46. The notch 15d, 25d, 35d, 45d gives the user a comfortable and safe grip, and thus facilitates the disassembling of the frame 1, if for example the user wishes to exchange the picture arranged in the picture frame 1.

The inner edge 16c, 26c, 36c, 46c is simultaneously an outer end edge of the receiving member 16, 26, 36, 46 and engages the ledge 15b, 25b, 35b, 45b of the connection element 15, 25, 35, 45.

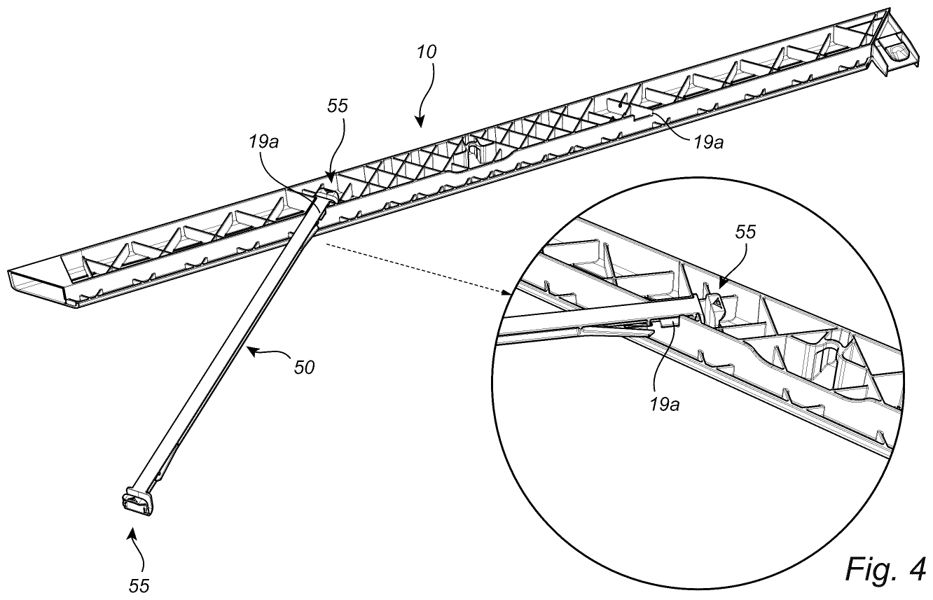

FIGS. 4, 5, and 6a-6b show an angle connection 50 attached to a first frame part 10. The angle connection 50 rests in the recess 19a of the frame part 10 and is releasably attached to the frame part 10 with a snap-fit connection, which will be described more in detail with reference to FIGS. 5 and 6b. Each end of the angle connection 50 comprises a snap-fit element 55. The snap-fit element 55 has a flexible arm 51 and a slot 52 (see FIG. 6b) configured to engage a cross rib 13 of the frame part 10. Further, the angle connection 50 comprises biasing means 53 configured to hold a picture and/or back surface of the frame 1 in place. The flexible arm 51 has a push feature 51a and two spaced-apart protrusions 51b.

FIG. 6b shows a cross-section of the snap-fit element 55 of the angle connection 50 connected to a frame part 10. To release the angle connection 50 from the frame part 10, the push feature 51a is pressed towards the biasing means 53 along the longitudinal direction L and lifted upwards, as indicated by the arrows in FIG. 6a. The biasing means 53 makes the picture frame 1 suitable for pictures and back sides of variable thickness, since the biasing means 53 is flexible and therefore adapts after the thickness of the material placed in the frame 1.

The angle connections 50 increase the bending stiffness of the frame 1. This results in that the wall thickness of the frame parts 10, 20, 30, 40 can be reduced to a low material consumption, resulting in a cheap and light frame 1.

The detachable angle connections 50 allow for an easy picture exchange in the picture frame 1. The snap-fit elements 55 makes the angle connections 50 easy to remove and reattach to the frame 1.

The frame parts 10, 20, 30, 40 are each formed in one piece. Further, each of the angle connections 50 are also formed in one piece. The frame parts 10, 20, 30, 40 and/or the angle connections 50 are formed from plastics. Preferably, the plastic used is a thermosetting plastic. The frame parts 10, 20, 30, 40 may be formed using injection moulding.

Hence, all frame parts 10, 20, 30, 50 may be snap-fitted with each other, and the angle connections 50 may be snap-fitted in turn to the frame parts 10, 20, 30, 40. This allow for an easy assembly for the user, and an easy process to exchange the picture arranged in the picture frame 1.

Without further elaboration, it is believed that one skilled in the art may, using the preceding description, utilize the present invention to its fullest extent. The preceding preferred specific embodiments are, therefore, to be construed as merely illustrative and not limitative of the disclosure in any way whatsoever.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different than those described above.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous.

In addition, singular references do not exclude a plurality. The terms “a”, “an”, “first”, “second” etc. do not preclude a plurality.

1. A picture frame comprising a first elongated frame part, a second elongated frame part, a third elongated frame part and a fourth elongated frame part,
wherein each elongated frame part comprises at a first end a connection element configured to releasably engage a receiving member arranged at a second end of another elongated frame part,
wherein each of said connection elements extends in a direction transversal to a longitudinal extension (L) of the elongated frame parts,
and wherein the connection element comprises a guiding protrusion configured to guide the connection element into the receiving member.

2. The picture frame according to claim 1, wherein the connection element and the receiving member together form snap-fit connection.

3. The picture frame according to claim 1, wherein the receiving member is an aperture, and the connection element comprises a male protrusion configured to be inserted into the aperture.

4. The picture frame according to claim 3, wherein the male protrusion has a ledge configured to engage an inner edge of the receiving member.

5. The picture frame according to claim 2, wherein the connection element comprises a notch configured to be pressed to release the connection element from the receiving member.

6. The picture frame according to claim 1, wherein the receiving member extends into the frame part in the longitudinal direction (L).

7. The picture frame according to claim 1, further comprising angle connections detachably connected to two adjacent elongated frame parts.

8. The picture frame according to claim 7, wherein said angle connections are connected to the picture frame with snap-fit elements arranged in each end of the angle connections.

9. The picture frame according to claim 7, wherein said angle connections comprise biasing means configured to abut and press a canvas, picture, passepartout or back surface arranged in the picture frame into place.

10. An elongated frame part comprising at a first end a connection element and a receiving member arranged at a second end,
wherein the connection element is configured to releasably engage the receiving member of another elongated frame part,
wherein the connection element extends in a direction transversal to a longitudinal extension (L) of the elongated frame part,
and wherein the connection element comprises a guiding protrusion configured to guide the connection element into the receiving member.

11. The elongated frame part according to claim 10, wherein the elongated frame part is formed in one piece.

12. The elongated frame part according to claim 10, wherein the elongated frame part is formed by injection moulding.

13. A method for manufacturing a picture frame, comprising steps of:
forming a first elongated frame part, a second elongated frame part, a third elongated frame part and a fourth elongated frame part,
wherein each elongated frame part comprises at a first end a connection element configured to releasably engage a receiving member arranged at a second end of another elongated frame part,
wherein each of said connection elements extends in a direction transversal to a longitudinal extension L of the elongated frame parts, and wherein the connection element comprises a guiding protrusion configured to guide the connection element into the receiving member; and
releasably connecting the elongated frame parts to each other to form said picture frame.

14. The method according to claim 13, wherein the step of forming the frame parts comprises injection moulding the frame parts.

15. The method according to claim 13, wherein the step of connecting the elongated frame parts comprises connecting the connection element of each elongated frame part with the receiving member of another elongated frame part.

16. The picture frame according to claim 7, wherein the picture frame comprises four of the angle connections.
